(19) United States
(12) Patent Application Publication
(10) Pub. No.: US 2005/0058501 A1
(43) Pub. Date: Mar. 17, 2005

(54) Disposable toothpaste dispensing toothbrush

(76) Inventor: Brent L. Evans, Kokomo, IN (US)

Correspondence Address: Frank D. Lachenmaier;Suite 200, 116 N. Main St., P.O. Box 1047, Kokomo, IN, 46903-1047, US

(21) Appl. No.: 10/661,667

(22) Filed: Sep. 12, 2003

(51) Int. Cl. A47L 13/22; A46B 11/04; B43M 11/06

(52) U.S. Cl. 401/183; 401/270; 401/291

(57) ABSTRACT

This invention generally relates to disposable toothpaste dispensing toothbrushes. More specifically this invention relates to a simpler and more economical approach to a dispensing toothbrush mounted as a permanent extension of a small toothpaste tube with internal channels to allow for toothpaste to be dispensed around the base of the bristles of the toothbrush when the tube of toothpaste is squeezed. The brush is used until the tube is empty and discarded, generating numerous oral hygiene benefits which are discussed in the specification.

### FEDERALLY SPONSORED RESEARCH

Not Applicable

### SEQUENCE LISTING OR PROGRAM

Not Applicable

### BACKGROUND

1. Field of Invention

This invention generally relates to disposable toothpaste dispensing toothbrushes. More specifically this invention relates to a simpler and more economical approach to a dispensing toothbrush mounted as a permanent extension of a small toothpaste tube with internal channels to allow for toothpaste to be dispensed out around the bristles of the toothbrush when the tube of toothpaste is squeezed. The brush which is permanently attached to the toothpaste tube is used until the tube is empty and discarded, generating numerous oral hygiene benefits which are discussed in the specification.

2. Prior Art

The prior art discloses numerous different techniques for dispensing toothpaste onto the top of toothbrush bristles or around their bases. There is a large amount of activity in the general field of toothpaste dispensing toothbrushes. Much of that activity is involved in the design or improvement of design of refillable tubes with some sort of advancing ram type paste feeding systems.

Inventors have acknowledged that a problem existed and have been proposing solutions since U.S. Pat. No. 3,741,667 Cesari 1973 disclosed a tooth brush with a handle mounted toothpaste supply to the top of the brush. See U.S. Pat. No. 3,864,047 Sherrod (1975) which discloses the first tooth brush with a handle mounted supply system that pumps the toothpaste out at the base of the bristles.

Cesari (1973) also discloses a common approach to loading toothpaste into a cavity or chamber in the handle and a rod-piston-advance type mechanism to force the toothpaste from the chamber onto or into the bristles of the attached toothbrush. More or less complicated similar concepts are disclosed in U.S. Pat. No. 3,864,047 Sherrod (1975), U.S. Pat. No. 3,937,235 Broughton (1976), U.S. Pat. No. 4,269,207 Konrad (1981), U.S. Pat. No. 438,011 Smith (1983), U.S. Pat. No. 4,522,524 Green (1985), U.S. Pat. No. 4,583,563 Turner (1986), U.S. Pat. No. 4,693,622 Booth (1987), U.S. Pat. No. 4,695,177 Kuo (1987), U.S. Pat. No. 4,787,765 Kuo (1988), U.S. Pat. No. 5,439,014 Moussa (1995), U.S. Pat. No. 5,842,487 Leder (1998), U.S. Pat. No. 5,911,532 Evancic (1999), U.S. Pat. No. 6,062,233 Williams (2000) and U.S. Pat. No. 6,334,451 Yang (2002).

U.S. Pat. No. 4,056,110 Landsman (1977), U.S. Pat. No. 5,028,158 Fey (1991), U.S. Pat. No. 5,244,298 Greenhouse (1993), U.S. Pat. No. 5,388,599 Yen (1995), U.S. Pat. No. 6,227,209 Kim (2001), and U.S. Pat. No. 6,325,076 Ramirez (2001) all utilize a conventional commercial toothpaste tube as the supply mechanism as opposed to the refillable cartridge.

Landsman has a very complex ratcheting mechanism activated by the movement of the brush or a lead screw with a wedge type squeeze mechanism.

Greenhouse discloses a rotating pin attached to the end of the toothpaste tube which when advanced along a curved slot, rolls up the toothpaste tube forcing toothpaste out on to the top of the brush. Yen discloses an assembly with a toothbrush and a tube of toothpaste in a lipstick type case that when rotated push up out of the case but the tube is not connected to and feeding through the brush. Ramirez and Kim likewise utilize a toothbrush and a tube of toothpaste fastened together but not feeding through the brush handle. Here the brushes have threaded ends that screw onto toothpaste tubes acting as caps, not conduits. Kim has a lower case made from a hard plastic to support the toothpaste tube but has an opening in the side to allow the thumb access to the tube to squeeze the toothpaste out of the tube and onto the top of brush which is then remounted to the toothpaste tube and lower case which becomes an extension of the toothbrush handle.

Fey discloses a replaceable tube of toothpaste with a toothpaste conveying toothbrush threaded onto the toothpaste tube. Fey discloses a cover to protect the sanitary condition of the brush when not in use and utilizes a squeezable lower case that fits over the tube which is made of a clear, flexible material.

### OBJECTS AND ADVANTAGES

Accordingly several objects and advantages of the present invention are:

(a) to provide a toothpaste dispensing toothbrush that encourages the user to throw it away when the paste supply expires avoiding poor cleaning caused by worn bristles.

(b) to provide a toothpaste dispensing toothbrush that assures the user's paste supply will not likely be contaminated by contact with someone else's brush.

(c) to provide a toothpaste dispensing toothbrush that can be utilized by a handicapped user with the use of only one hand.

(d) to provide a toothpaste dispensing toothbrush that is economical enough to produce that dentists will be encouraged to give to patients as promotional items.

(e) to provide a toothpaste dispensing toothbrush that is cleaner to use with no excess toothpaste on the tube or surrounding areas and no cap to fall on the floor and be returned to the tube.

(f) to provide a toothpaste dispensing toothbrush that has its own personal toothpaste supply for children such that parents can monitor daily use at a glance where several children previously were sharing a tube of toothpaste.

(g) to provide a toothpaste dispensing toothbrush that allows more toothpaste to be dispensed while brushing if desired.

Further objects and advantages will become apparent from a consideration of the ensuing description and drawings.

### SUMMARY

In accordance with the present invention, an improved apparatus for oral hygiene is comprised of a hollow toothbrush head mounted on a hollow toothbrush handle which is mounted permanently to an open toothpaste tube which is sized to hold just enough toothpaste as to run out simultaneously with the wearing of the toothbrush bristles to an unacceptable level in terms of their ability to properly clean the user's teeth. The tube end is filled with toothpaste by the toothpaste supplier and sealed. The brush head is hollow with channels from the top of the tube to the several openings at the base of the bristles such that when the tube is squeezed a small amount of paste is dispensed onto the base of the bristles. A plastic cap may be snapped over the toothbrush end when not in use to keep the brush clean and also to prevent tooth paste from being squeezed out accidentally in transit or drying out if not used for a long period of time.

The foregoing and other objects and advantages will appear from the description to follow. Reference is made in the description to the accompanying drawings which form a part hereof. The accompanying drawings show, by way of illustration, specific embodiments in which the invention is practiced whereby the toothpaste dispensing tooth brush is approximately sized for an adult user and a second embodiment which includes a snap on travel cover. The embodiments will be described in sufficient detail to enable those skilled in the art to practice the invention, and it is to be understood that other embodiments may be utilized and that structural changes may be made without departing from the scope of the invention. For example brushes in different colors might be utilized to help children identify their personal toothpaste dispensing toothbrush or favorite cartoon characters might grace the handle sections to encourage use. The size and shape of the apparatus shown in the attached drawings is for illustrative purpose only and is not intended to limit the application as to scaling that will be obvious to one skilled in the art of toothbrush design. In the accompanying drawings, like reference characters designate the same or similar parts throughout the several views.

### DRAWINGS

Drawing Figures

FIG. 1 shows a front view of the toothpaste dispensing toothbrush

FIG. 2 shows a right side view of the toothpaste dispensing toothbrush.

FIG. 3 shows a partial section view of the toothpaste dispensing toothbrush.

FIG. 4 shows a front view of the toothpaste dispensing toothbrush with its travel cover in place.

FIG. 5 shows a partial enlarged view of the travel cover snap latch to the toothpaste dispensing toothbrush.

### REFERENCE NUMERALS IN DRAWINGS

10—toothpaste dispensing toothbrush
12—toothpaste tube
14—toothbrush handle
16—toothbrush bristles
18—toothbrush head
19—bristle head interface
20—toothpaste dispensing orifices
21—toothpaste conducting head channel
22—toothpaste conducting handle channel
24—plastic travel cover
26—toothbrush cover retaining ring
28—travel cover snap
30—seal
32—second embodiment with travel cover

### DETAILED DESCRIPTION

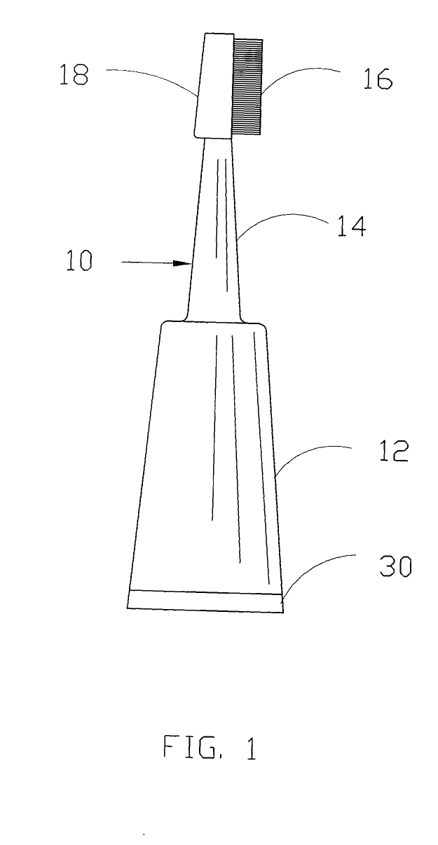

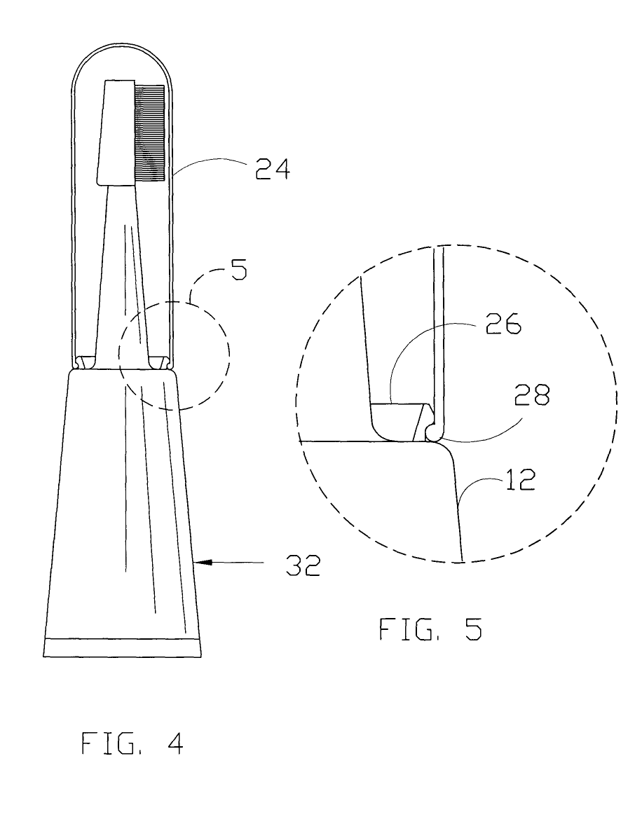

In order that the invention may be more fully understood it will now be described, by way of example, with reference to the accompanying drawings in which FIGS. 1 through 3 illustrate a preferred embodiment of the present invention wherein a toothpaste dispensing toothbrush apparatus is disclosed. FIGS. 4 and 5 disclose another embodiment including travel cover 24.

Turning to FIG. 1, therein is shown toothpaste dispensing toothbrush 10 in a front view. This view discloses standard toothbrush bristles 16 fixably attached to toothbrush head 18 in a conventional manner that is fixably attached to toothbrush handle 14 which is in turn fixably attached to toothpaste tube 12. Toothpaste tube 12 is filled with toothpaste by the toothpaste supplying company in a conventional manner with a sufficient quantity of toothpaste to last for as many brushings as oral hygienists/dentist recommend with one brush (approximately 21 grams). The bottom of toothpaste tube 12 is then closed at seal 30 in a conventional manner.

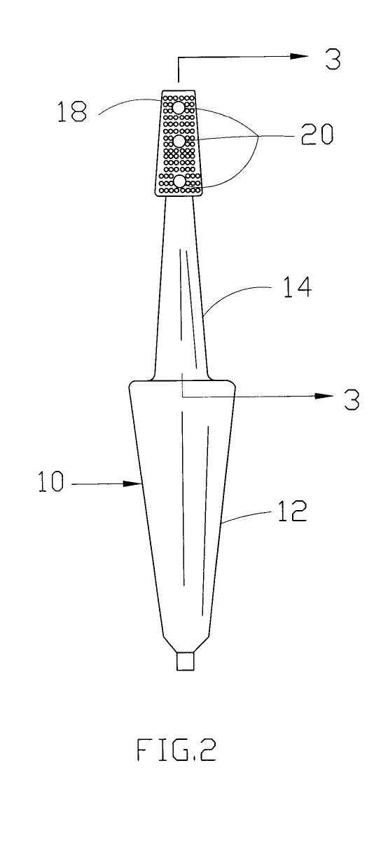

FIG. 2 shows a side view of toothpaste dispensing toothbrush 10 and the partial section line 3-3 through head 18, dispensing orifices 20 and handle 14.

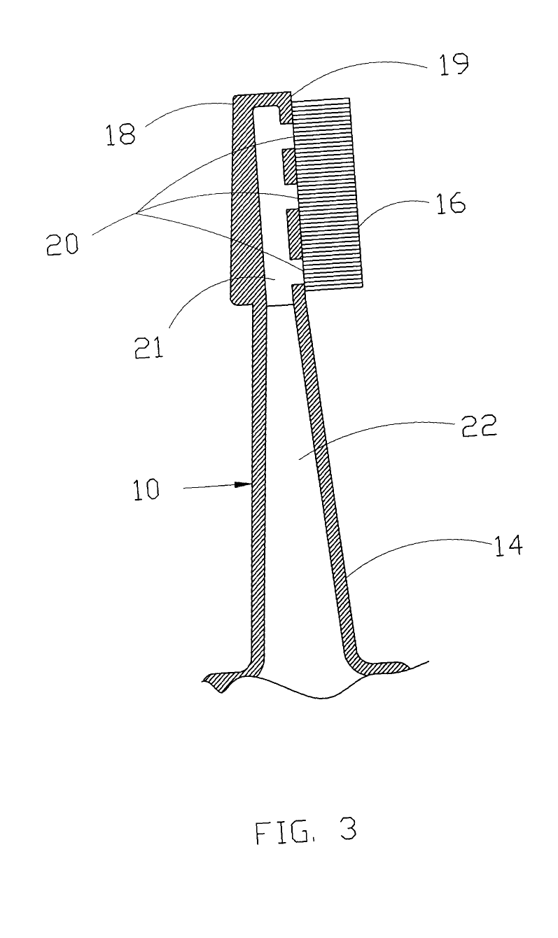

FIG. 3 shows that section view of toothpaste conducting head channel 21, toothpaste conducting handle channel 22, orifices 18 and bristles 16.

FIGS. 4 and 5 show a second embodiment 32 of toothpaste dispensing toothbrush 10 which includes all the same elements as toothbrush 10 but also includes travel cover 24 which is held in place by travel cover snap 28 popping over toothbrush cover retaining ring 26.

Operation:

Toothpaste dispensing toothbrush 10 is filled at the toothpaste supplier with sufficient toothpaste to last approximately as long as the bristles 16 in brush head 18 and thus encourages the user to dispose of the expired unit and replace it with a new brush 10 with its new supply of toothpaste before the cleaning capability of bristles 16 have deteriorated to an unacceptable level.

Since each brush 10 has its own toothpaste supply there is no danger of any cross-contamination from one child to another as frequently occurs when they share a common lavatory and toothpaste tube which has been in contact with another's brush.

The dispensing toothbrush 10 can be utilized by a handicapped user with the use of only one hand as there is no toothpaste cap to unscrew or a separate brush to hold in one hand while squeezing toothpaste from the tube onto the brush with the other. The second embodiment 32 includes travel cover 24 that can be easily removed by pressing cover 24 with a thumb while holding the tube end 12 in the same hand.

Toothpaste dispensing toothbrush 10 as described above is economical to produce as it may be a one shot plastic molded part including toothbrush head 18, handle 14 and an open ended toothpaste tube 12. Bristles 16 can be inserted in a conventional manner and the tube filled with toothpaste and closed at seal 30. The travel cap may be a reusable and either included in a package or sold as a separate item. Dentists often pass out new toothbrushes and tubes of toothpaste to their customers as promotional items at each visit and would want to encourage their clients to begin utilization of a superior system such as toothpaste dispensing toothbrush 10.

Toothpaste dispensing toothbrush 10 is cleaner to use with no excess toothpaste on the tube or surrounding areas as the brushing procedure is to wet the brush and actually have the brush 10 in your mouth before squeezing the toothpaste tube end 12. Additional paste can be applied during brushing if required by simply squeezing again. Brush 10 is rinsed as normal and hung in the conventional toothbrush holder after brushing. Also, there is no cap to fall on the floor and be returned to the tube.

Where several children are using the same tube of toothpaste it is difficult for a parent to know that each child is complying with the required daily routine of oral hygiene. Each toothpaste dispensing toothbrush 10 has its own personal toothpaste supply for children such that parents can monitor daily use at a glance.

While I have explained my invention in detail with the aid of exemplary embodiment thereof, it will be understood that the invention is not limited to the specific constructional details shown and described by way of example, which may be departed from without departing from the scope and spirit of the invention and is only limited by the appended claims.

1. A disposable toothpaste dispensing toothbrush comprising:
(a) a toothbrush head of conventional size and shape with toothbrush bristles fixably attached with several dispensing orifices beginning at the bristle head interface of said toothbrush head and connecting to an internal toothpaste conducting head channel;
(b) a toothbrush handle fixably attached to said toothbrush head with an internal toothpaste conducting handle channel connecting to said toothpaste conducting head channel; and
(c) a toothpaste tube fixably attached to said toothbrush handle with an opening from said toothpaste conducting handle channel to the inside of said toothpaste tube which has been sized such that the toothpaste supply expires before said toothbrush bristles are worn enough to lose their cleaning effectiveness.

2. A disposable toothpaste dispensing toothbrush as defined in claim 1 whereby said toothbrush heads and handles are supplied in different colors to assist in brush identification.

3. A disposable toothpaste dispensing toothbrush as defined in claim 1 further comprising a plastic travel cover which is of an elongated tubular shape for covering said toothbrush head section, wherein said tubular travel cover has a cover opening and an opening rim, and wherein at least one boss is formed on and along an inner periphery of the opening rim so that the opening rim can be detachably fitted onto the toothbrush cover retaining ring fixably attached to the top external surface of said toothpaste tube.

4. A disposable toothpaste dispensing toothbrush as defined in claim 3 whereby said toothbrush travel covers are supplied in different colors to assist in brush identification.

5. A disposable toothpaste dispensing toothbrush as defined in claim 3 whereby said toothbrush travel covers are supplied with favorite cartoon characters to make the brushing experience fun for children.
